(19) United States
(12) Patent Application Publication
(10) Pub. No.: US 2007/0098209 A1
(43) Pub. Date: May 3, 2007

(54) Integrated multi yoke for multi polar loudspeakers

(75) Inventors: J. Dwidjaja Setiabudi, Kudus (ID); Adisusanto, Kudus (ID); Setiawan Yusran, Kudus (ID); Hadi Prayitno, Kudus (ID); Nafis Dwi Cahyo, Kudus (ID); Andi Setiawan, Kudus (ID); Fx Darmojo Sokti, Kudus (ID)

Correspondence Address: ROTHWELL, FIGG, ERNST & MANBECK, P.C., 1425 K STREET, N.W., SUITE 800, WASHINGTON, DC, 20005, US

(73) Assignee: PT. Hartono Istana Teknologi, Kudus (ID)

(21) Appl. No.: 11/259,040

(22) Filed: Oct. 27, 2005

(51) Int. Cl. H04R 9/06

(52) U.S. Cl. 381/420; 381/412

(57) ABSTRACT

An integrated multi yoke and loudspeaker system incorporating the yoke for providing a path for the magnetic field of each driver, resulting in higher magnetic field strength and thus a higher sound pressure level. The loudspeaker incorporating the yoke takes a smaller loudspeaker enclosure volume and has a wider sound dispersion. The yoke is configured to provide a common partition for all the drivers to which it is connected.

### FIELD OF THE INVENTION

The present invention relates to a loudspeaker system and more particularly to a new yoke configuration that provides improved magnetic field strength as well as a higher sound pressure level.

### BACKGROUND OF THE INVENTION

Modern audio video equipment such as LCD TV, Plasma TV, and wall mounted DVD players are becoming increasingly thinner in dimension. This influences the development of loudspeaker systems with the objective to be as thin as possible or as small as possible for the enclosure size, while retaining high quality sound.

To produce a good sound quality of the loudspeaker driver, appropriate loudspeaker parameters are required. One parameter is a high magnetic field strength (B) at the magnetic gap of the driver motor system. The benefit of a higher magnetic field strength (B) is higher sound pressure level (SPL).

Separate bi-polar loudspeakers are known to improve sound dispersion. The system uses two drivers assembled back-to-back and connected in phase. Although effective, the system tends to be bulky and inappropriate for modern thin audio video equipment.

By using the invented integrated multi yoke structure, the size problem maybe mitigated. The integrated multi yoke structure may be used in bi-polar, tri-polar, quadro-polar, penta-polar or hexa-polar loudspeaker systems. The advantage of this system is both wider sound dispersion and higher magnetic field strength (B) in a smaller loudspeaker enclosure size. This invention is applicable for television loudspeakers, high fidelity loudspeakers, car loudspeakers, multimedia loudspeakers, ceiling loudspeakers, sub-woofers, cone type, dome type, and horn type drivers among others.

### SUMMARY OF THE INVENTION

One object of one embodiment of the present invention is to provide a loudspeaker driver motor system for combining and driving two or more loudspeakers, with an integrated yoke structure for providing a path for the magnetic field of each driver.

A further object of one embodiment of the present invention is to provide an integrated multi yoke for use in a loudspeaker having at least two loudspeaker drivers, comprising: a body having at least two recesses each for receiving a loudspeaker driver; and a partition common to each recess. The modified yoke results in a loudspeaker having a wider sound dispersion and higher magnetic field strength (B) in a smaller loudspeaker enclosure size. Compared to conventional bi-polar loudspeakers, which having the same specification, the present technology provides a smaller loudspeaker enclosure and has a higher SPL.

A further object of one embodiment of the present invention is to provide a loudspeaker, comprising: an enclosure; a plurality of individual loudspeaker drivers including a diaphragm, spider, frame, top plate and magnet, the individual loudspeaker drivers being mounted adjacent one another within the enclosure; and a yoke commonly connected to each of the individual loudspeaker drivers.

Another object of one embodiment of the present invention is to provide a loudspeaker driver motor system for combining and driving two loudspeakers, comprising: a cylindrical magnet, a ring magnet at the outer of said cylindrical magnet, a yoke structure of a non magnetic material to align both magnets on a common axis, a plate system that consists of a ring and a disk covering both sides of both magnets. Using this invented motor system for a bi-polar loudspeaker system can produce a higher magnetic field strength (B) and wider sound dispersion in a smaller loudspeaker enclosure.

A further object of one embodiment of the present invention is to provide a smaller bi-polar loudspeaker system with a high SPL, comprising: an enclosure; two loudspeaker drivers including a diaphragm, spider, frame, top plate; the individual loudspeaker drivers being mounted adjacent one another within the enclosure; a ring magnet, a cylindrical magnet and a yoke commonly connected to each of the individual loudspeaker drivers. Compared to conventional separate bi-polar loudspeakers, that have similar electrical specification, the present invention provides the smallest loudspeaker enclosure with a higher SPL.

A still further object of one embodiment of the present invention is to provide a method for elevating the sound pressure level of a loudspeaker, comprising: providing a loudspeaker enclosure having a plurality of individual loudspeaker drivers; providing a yoke mounted within the enclosure commonly connected to each of the individual loudspeaker drivers for symmetrizing the magnetic fields generated from the drivers to increase the strength of the magnetic fields; and passing a signal through the drivers under a stronger magnetic field resulting from the symmetrized fields whereby the sound pressure level is elevated.

Having thus generally described the invention, reference will now be made to the accompanying drawings.

### BRIEF DESCRIPTION OF THE DRAWINGS

FIG. 1 is a cross-sectional view of the prior art system having a separate bi-polar loudspeaker and incorporating two drivers assembled back-to-back, with a U-yoke;

FIG. 2a is a cross-sectional view of one embodiment of the present invention in a bi-polar loudspeaker with an I-Yoke configuration;

FIG. 2b is an exploded view of FIG. 2a;

FIGS. 3a through 3c are schematic illustrations of the plurality of pole geometries of I-Yoke configuration;

FIG. 4 is a cross-section of a prior art bi-polar loudspeaker using two driver mounted adjacent one another using U-yoke;

FIG. 5a is a cross-sectional view of a further embodiment of the present invention in a bi-polar loudspeaker with S-yoke configuration;

FIG. 5b is an exploded view of FIG. 5a;

FIG. 6 is a cross-sectional view of a loudspeaker system with an integrated multi U-yoke with three yokes, according to one embodiment of the present invention;

FIG. 7 is a cross-sectional view of a loudspeaker system having an integrated multi U-yoke with four yokes, according to a further embodiment of the present invention;

FIG. 8 is a perspective view of a loudspeaker system having an integrated multi U-yoke with five yokes, according to one embodiment of the present invention;

FIG. 9 is a perspective view of a loudspeaker system having an integrated multi U-yoke with six yokes, according to one embodiment of the present invention;

FIG. 10 is a cross-sectional view of a loudspeaker system having an integrated multi U-yoke with three yokes where two are used for mid-bass driver and the remainder for the tweeter driver;

FIG. 11 is a cross-sectional view of a loudspeaker system having an integrated multi U-yoke with four yokes;

FIG. 12 is a cross-sectional view of a loudspeaker system having an integrated I-Yoke configuration according to one embodiment of the present invention using a separate tweeter driver assembly in the same loudspeaker enclosure;

FIG. 13 is a cross-sectional view of a loudspeaker system having an integrated I-Yoke configuration according to one embodiment of the present invention using a separate tweeter driver and separate midrange driver assembly in the same loudspeaker enclosure;

FIG. 14 is a cross-sectional view of a loudspeaker system having an integrated four U-yoke configuration according to one embodiment of the present invention using a separate dynamic reflection 4π steradian omni-directional tweeter assembly in the same loudspeaker enclosure;

FIG. 15 is a cross-sectional view of a prior art assembly of a separate bi-polar loudspeaker using two drivers assembled back-to-back and using T-yoke configuration;

FIG. 16a is a cross-sectional view of one embodiment of the present invention illustrating a bi-polar loudspeaker with a cross-yoke configuration;

FIG. 16b is an exploded view of FIG. 16a;

FIGS. 17a through 17c are schematic illustrations of the plurality of pole geometries of a cross-yoke configuration;

FIG. 18 is a cross-sectional view of another prior art assembly of a separate bi-polar loudspeaker, using two drivers assembled side by side and back-to-back using a T-yoke configuration;

FIG. 19a is a cross-sectional view of a bi-polar loudspeaker with T-yoke configuration and top-plate combination configuration according to a further embodiment of the present invention;

FIG. 19b is an exploded view of FIG. 19a;

FIG. 20 is a cross-sectional view of a loudspeaker system having an integrated cross-yoke configuration according to one embodiment of the present invention using a separate tweeter driver assembled in the same loudspeaker enclosure;

FIG. 21 is a cross-sectional view of a loudspeaker system having an integrated cross-yoke configuration according to one embodiment of the present invention using a separate tweeter driver and midrange driver assembly in the same loudspeaker enclosure;

FIG. 22 is a cross-sectional view of a loudspeaker system having an integrated T-yoke configuration & plate combination configuration, assembled with a separate tweeter driver in the same loudspeaker enclosure; and

FIG. 23a is a cross-sectional view of the invented bipolar loudspeaker system having a ring magnet, a cylindrical magnet and a yoke commonly connected to each of said individual loudspeaker drivers.

FIG. 23b is an exploded view of FIG. 23a.

FIG. 24 is a graphical representation of a frequency response measurement comparison between the prior art bi-polar loudspeaker using T-yoke and cross-yoke configuration according to the present invention.

### DETAIL DESCRIPTION OF THE PREFERRED EMBODIMENTS

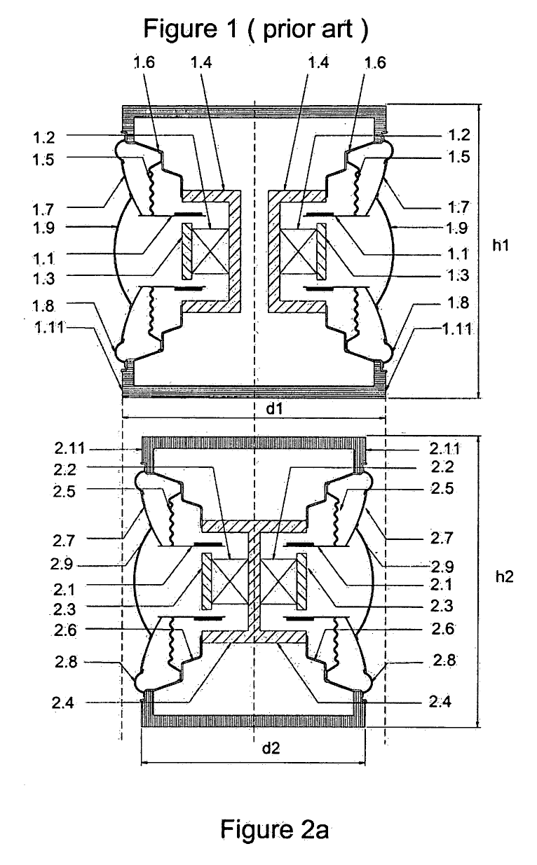

Referring to FIG. 1, shown is the prior art separate bi-polar loudspeaker system. It uses two drivers assembled back-to-back and connected in phase. Each driver has a motor system consisting of a voice coil [1.1], a magnet [1.2], a top plate [1.3] and a U-yoke [1.4]. The U-yoke [1.4] has the form of a hollow structure with a bottom plate, forming a cross-sectional view U shape. A spider [1.5] as the compliance system of the driver is connected to frame [1.6] and voice coil [1.1]. A diaphragm [1.7] has an edge [1.8] connected to frame [1.6] and voice coil [1.1]. A dust cover [1.9] is provided at the front of the diaphragm [1.7]. Both drivers are assembled within a loudspeaker enclosure [1.11]. The total thickness of the loudspeaker enclosure is (d1) with (h1) representative of the height of both loudspeakers.

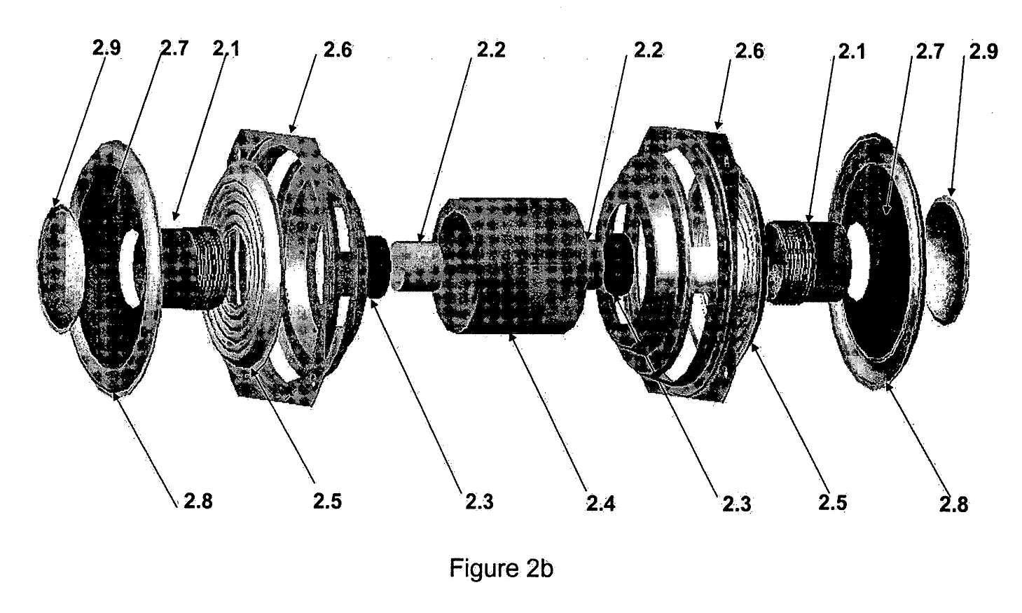

The numbering system for the remaining Figures will follow from FIG. 1. Thus 2.1, 2.2, 2.3, etc. will denote similar components in FIG. 2 et seq. as those from FIG. 1.

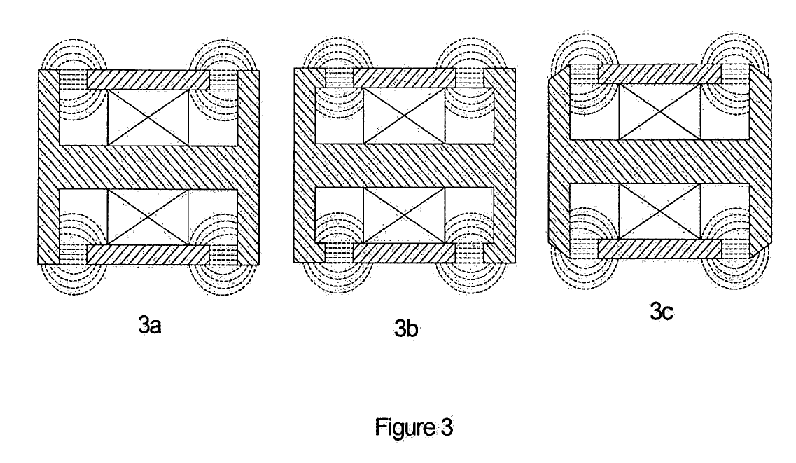

Referring now to FIG. 2a, shown is a cross-sectional view with FIG. 3b illustrating an exploded view of the invented bi-polar loudspeakers using an integrated I-Yoke configuration. Each driver has a voice coil [2.1], a magnet [2.2], a top plate [2.3] and an integrated I-Yoke configuration [2.4]. The yoke [2.4] is hollow with a horizontal mid partition forming, in cross-section an I Shape with plurality of pole geometries made of a permeable material. A spider [2.5], as the compliance system of the driver, is connected to frame [2.6] and voice coil [2.1]. The diaphragm [2.7] has an edge [2.8] connected to frame [2.6] and voice coil [2.1]. A dust cover [2.9] is provided at the front of the diaphragm [2.7]. Both drivers are within the loudspeaker enclosure [2.11]. The total thickness of the loudspeaker enclosure is (d2), the height of both loudspeakers is (h2), the same dimension as (h) in FIG. 1. By comparison with the prior art assembly in FIG. 1, the present loudspeaker has a smaller loudspeaker enclosure. This is due to the fact that the prior art arrangement has two bottom plates and distance between the two loudspeakers; the I-Yoke configuration according to the present invention has one bottom plate acting as a mid partition.

The integrated I-Yoke configuration [2.4] made by casting, die-casting, machining, hot or cold forging, snap parts, joining the parts with adhesive or by welding.

Referring now to FIG. 3, shown is an example of the plurality of pole geometries attributable to the I-Yoke configuration. FIG. 3a illustrates a straight U-yoke. FIG. 3b illustrates an under cut U-yoke. FIG. 3c illustrates an angled U-yoke. Pole geometries at FIGS. 3b and 3c have a more symmetrical magnetic field compared to the straight U-yoke geometry at FIG. 3a.

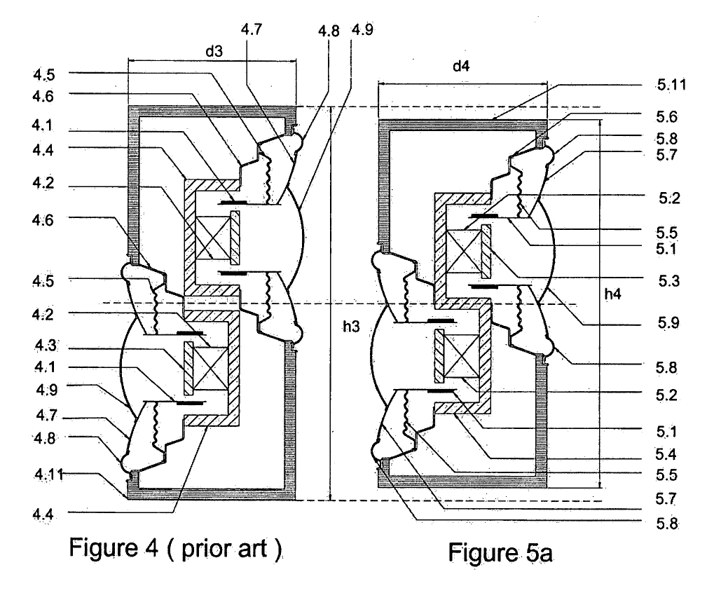

Referring to FIG. 4, shown is a prior art assembly of a separate bi-polar loudspeaker system. The construction of the driver is the same as that shown in FIG. 1, with the exception that the driver placement position is adjacent one another. In this configuration, the total thickness of the loudspeaker enclosure is (d3) which is less than (d1) in FIG. 1. However, the total height of both loudspeakers (h3) is higher than (h1) in FIG. 1.

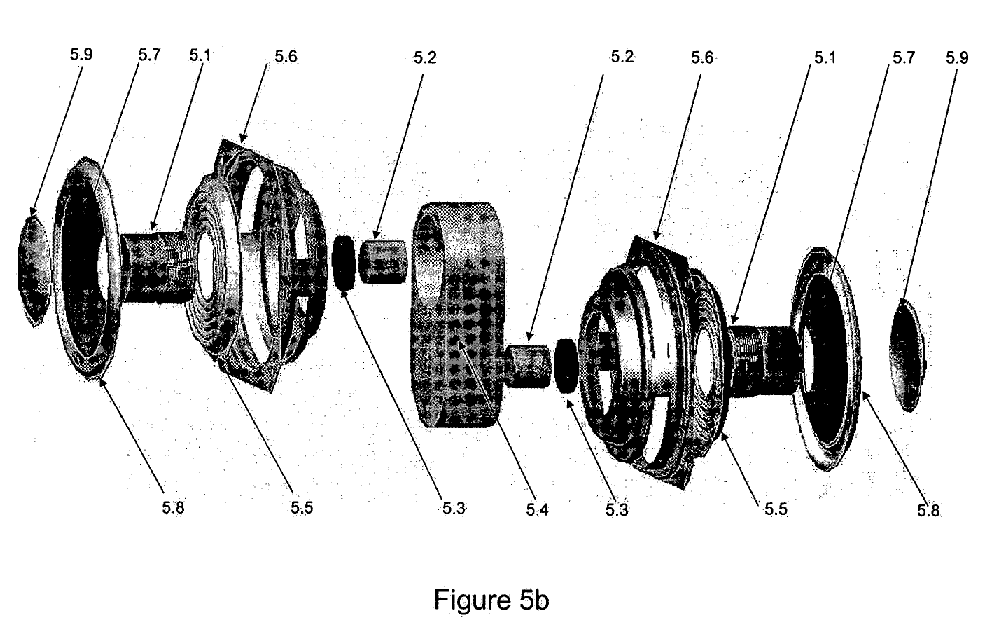

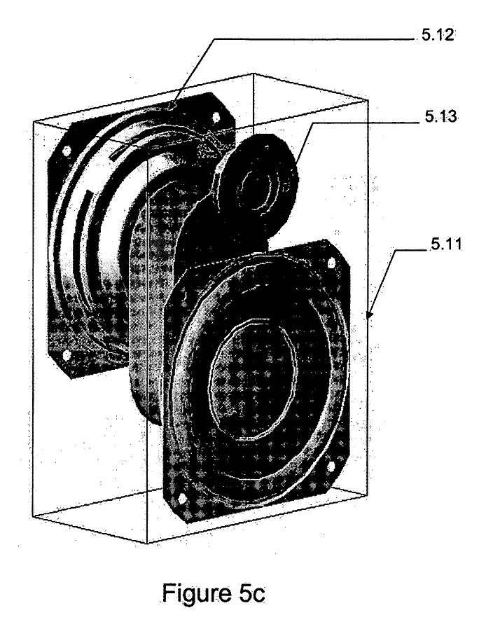

FIG. 5a is a cross-sectional view and FIG. 5b an exploded view of the bi-polar loudspeaker system with S-yoke configuration. It includes an integrated two U-yoke arrangement and is mounted adjacent one another forming cross-sectional view, an S shape. Each driver consists of a voice coil [5.1], a magnet [5.2], a top plate [5.3] and an integrated S-yoke configuration [5.4] made of two U-yokes assembled opposite side by side with interconnected sides. This forms an S shape with plurality of pole geometries. A spider [5.5] is connected to the frame [5.6] and the voice coil [5.1]. The diaphragm [5.7] has an edge [5.8] connected to the frame [5.6] and the voice coil [5.1]. The dust cover [5.9] is at the front of the diaphragm [5.7]. Both drivers as in previous examples are assembled in the loudspeaker enclosure [5.11]. The total thickness of the loudspeaker enclosure is (d4) and the height of both loudspeakers in series is (h4). Thus, the total height of both loudspeakers in series (h4) is less than (h3) in FIG. 4.

Referring now to FIG. 5c, shown is a perspective view of FIG. 5a with an additional tweeter [5.13] placed at the upper of one of the mid bass drivers [5.12]. The integrated S-yoke configuration [5.4] may be made from materials discussed previously with a layer between the parts that may be composed of polypropylene, engineering plastic, paper, ceramic, wood, acoustic foam, expanded polystyrene, rubber, air-bag, metal, etc.

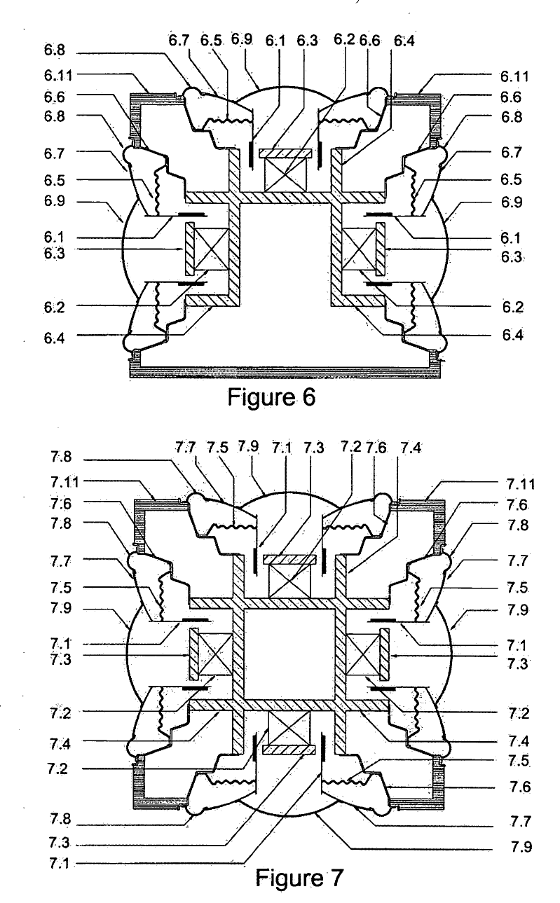

Referring to FIGS. 6 and 7, shown are examples of a multi polar loudspeaker system having an integrated multi U-yoke, according to the present invention. The structure is similar to that shown in FIG. 2, with a different yoke configuration. FIG. 6 is multi polar loudspeaker with three-yoke configuration [6.4]. Loudspeakers with this configuration assembled in a regular rectangular enclosure provide a tri-polar loudspeaker system. FIG. 7 is multi polar loudspeaker with four-yoke configuration [7.4]. Loudspeakers with this configuration assembled in a regular rectangular enclosure produce quadro-polar loudspeaker system.

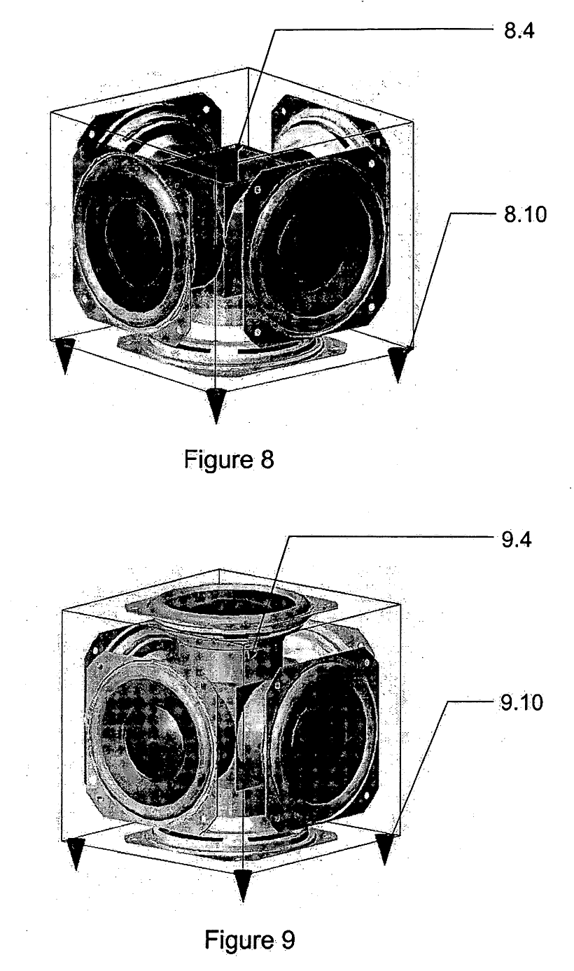

FIGS. 8 and 9 illustrate a multi polar loudspeaker having an integrated multi U-yoke, according to the present invention. Structurally, the arrangement is similar to that shown in FIG. 2, with a different yoke configuration. FIG. 8 illustrates a multi polar loudspeaker with five yoke configuration [8.4]. Loudspeakers with this configuration assembled in regular rectangular enclosures provide a penta-polar loudspeaker system. FIG. 9 illustrates a multi polar loudspeaker with a six-yoke configuration [9.4]. Loudspeakers with this configuration assembled in a regular rectangular enclosure provide a hexa-polar loudspeaker system. If one of the drivers is assembled in down firing position, it has four spacers or enclosure spikes [8.10 ] and [9.10].

The integral multi U-yoke discussed above may be made of highly permeable material with or without a hollow center for electronic circuitry mounting and/or cooling.

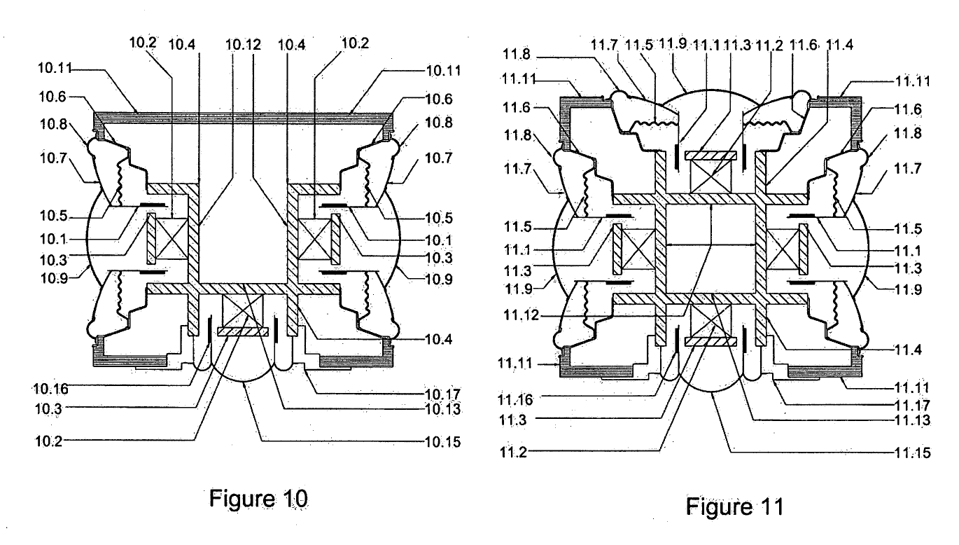

FIG. 10 illustrates an example of a loudspeaker system having an integrated multi U-yoke with three yokes, where two are used for the mid-bass driver [10.12] and the others for the tweeter driver [10.13]. The structure for the mid-bass driver is the same as FIG. 2, while the tweeter driver has a dome shaped diaphragm [10.15] connected with a high frequency voice coil [10.16] and a centering plate [10.17] made of polypropylene, nylon or plastic fiber.

The mid-bass driver is positioned at the left and right sides of the loudspeaker enclosure; the tweeter driver is positioned at the front side of the loudspeaker enclosure.

FIG. 11 illustrates a further example of a loudspeaker using an integrated multi U-yoke with four-yokes. One of the yokes is used for tweeter driver [11.13], usually assembled at the front side of the loudspeaker enclosure [11.11], the others for mid-bass drivers [11.12].

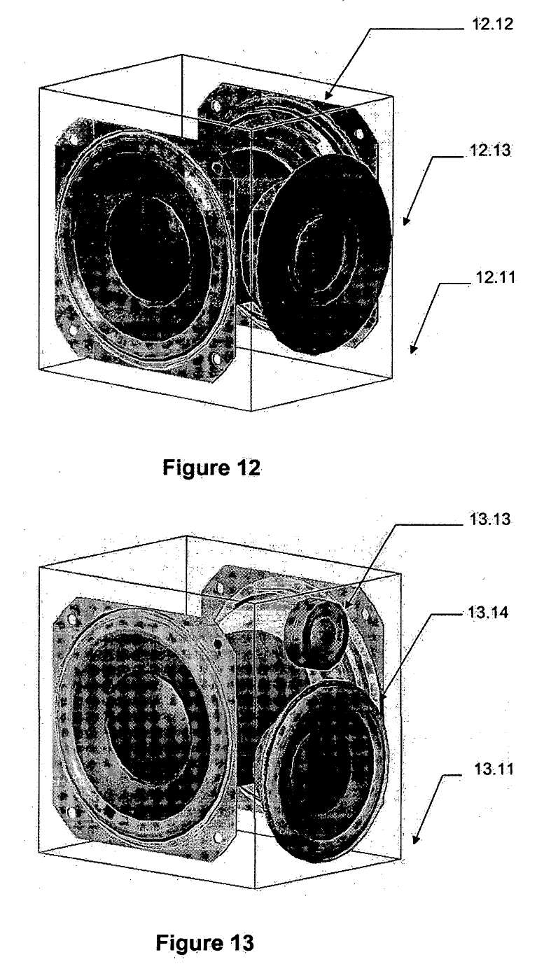

FIG. 12 illustrates a loudspeaker system having an integrated I-Yoke configuration according to the present invention with a separate tweeter driver [12.13] assembly in the same loudspeaker enclosure [12.11]. The tweeter driver [12.13] placement in this embodiment is in the front side of the loudspeaker enclosure, while the mid-bass driver [12.12] placement is at the left and right side of the loudspeaker enclosure.

FIG. 13 illustrates a loudspeaker system having an integrated I-Yoke configuration according to the present invention using a separate tweeter driver [13.13] and midrange driver [13.14] assembly in the same loudspeaker enclosure [13.11]. The tweeter and midrange drivers are placed in the front side of the loudspeaker enclosure; while the mid-bass driver [13.12] placement is at the left and right side of the loudspeaker enclosure.

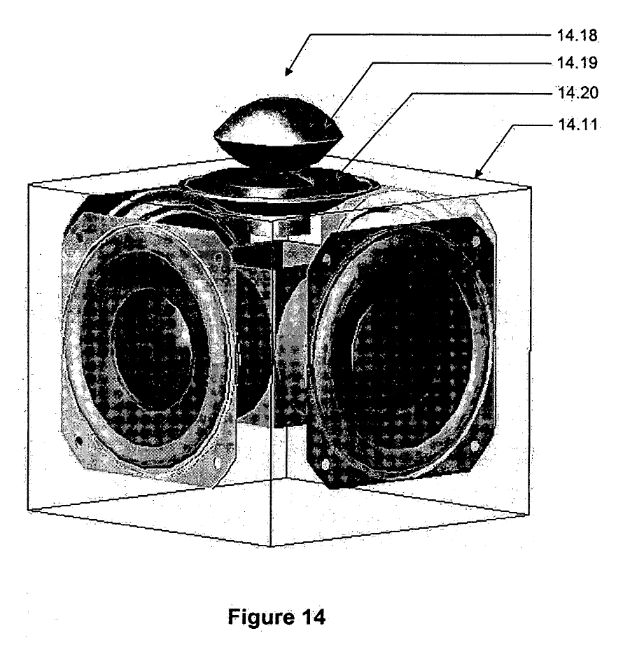

FIG. 14 illustrates a loudspeaker system having an integrated four U-yoke loudspeaker system with one separate dynamic reflection 4π steradian omni-directional tweeter [14.18] assembly in the same loudspeaker enclosure, the tweeter being positioned at the top side. By making use of the dynamic reflection 4π steradian omni-directional tweeter, the sound dispersion of the loudspeaker is omni directional.

The dynamic reflection 4π steradian omni-directional tweeter includes a closed hollow body [14.19] acting as a dynamic reflector connected at the center top side of a diaphragm [14.20]. A voice coil [14.21] drives the conical diaphragm [14.20]. The closed hollow body may be the shape of a sphere, spheroid, prolate spheroid, ellipse, ellipsoid, prolate ellipsoid, cylindrical, oblate shape, egg shape. Preferably the closed hollow body is made of substance that has a light, rigid, seamless and uniform thickness similar to the natural shell of a bird egg. The dynamic reflector in the present invention moves simultaneously with its diaphragm to produce an omni directional radiation pattern.

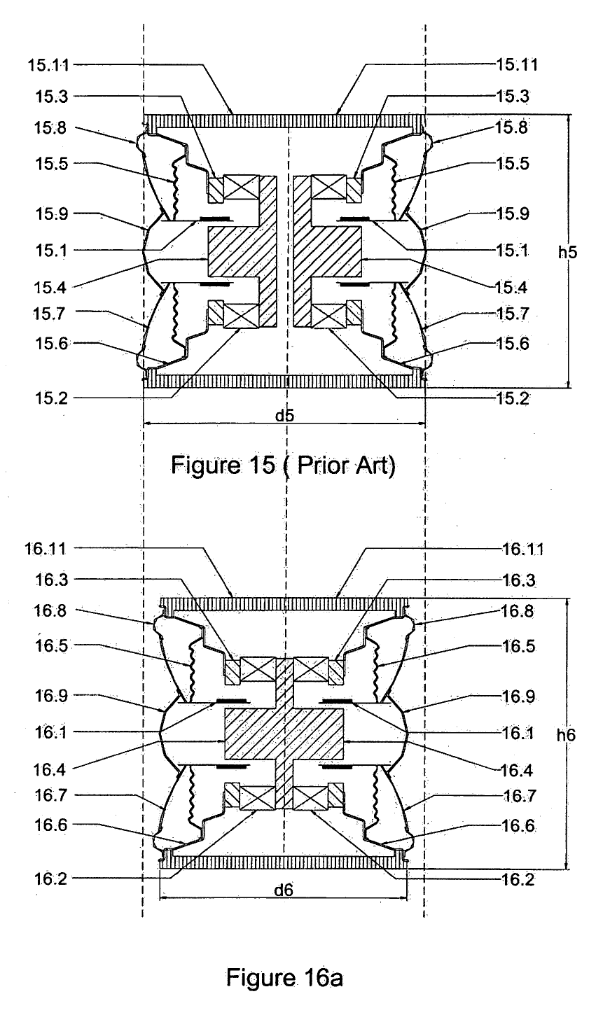

FIG. 15 illustrates a prior art bi-polar loudspeaker, using two drivers in back-to-back relation, connected in phase and using T-yoke configuration. The T-yoke configuration may take the form of a plate with a center shaft protruding at the topside forming a T shape, with plurality of pole geometries. The structure illustrated in FIG. 15 is similar to that shown in FIG. 1, but uses a T-yoke configuration [15.4] instead of a U-yoke [1.4]. The magnet [15.2] has a ring shape and the top plate [15.3] also has a ring shape, instead of cylindrical shape [1.2] and [1.3]. Both drivers are assembled within the loudspeaker enclosure [15.11]. The total thickness of the loudspeaker enclosure is (d5); (h5) is the height of both loudspeakers.

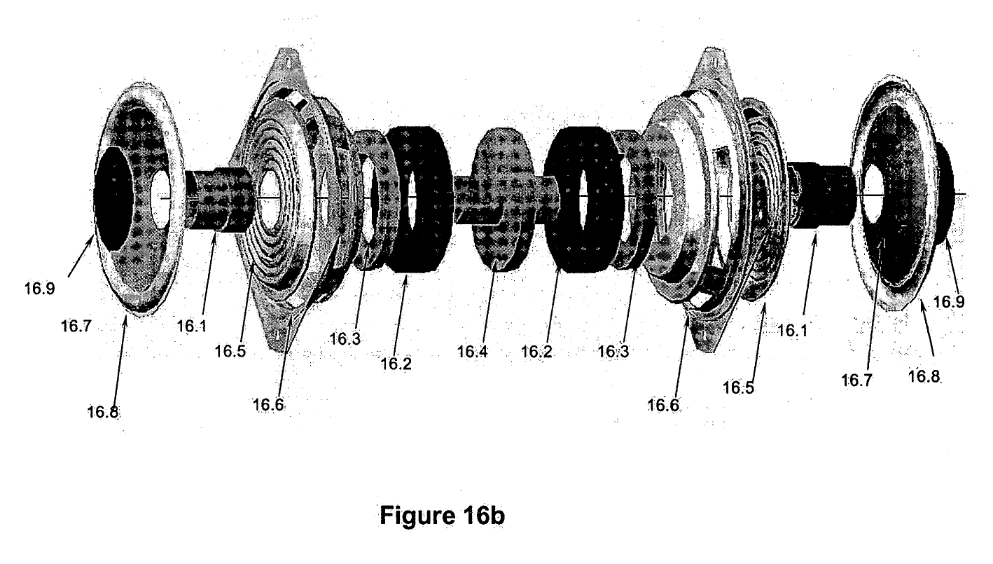

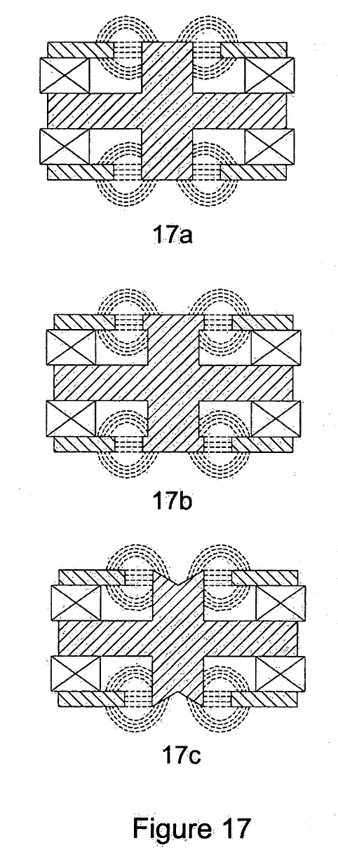

Referring to FIGS. 16a and 16b, shown is an example of a bi-polar loudspeaker using an integrated cross-yoke configuration. Each driver includes the voice coil [16.1], a magnet [16.2], a top plate [16.3] and an integrated cross-yoke configuration [16.4]. The invented yoke takes the form of a plate with center shaft protruding from both the left and right sides forming a cross-sectional cross (+) shape, with plurality of pole geometries (FIG. 17). A spider [16.5] is connected to the frame [16.6] and the voice coil [16.1]. The diaphragm [16.7] has an edge [16.8] connected to frame [16.6] and voice coil [16.1]. Dust cover [16.9] is provided at the front of the diaphragm [16.7].

The total thickness of the loudspeaker enclosure [16.11] is (d6), with the height of the enclosure being designated by (h6). In comparison to FIG. 15, (d6) is less than (d5) thus, the invented loudspeaker has a smaller loudspeaker enclosure.

Referring to FIG. 17, shown is the plurality of pole geometries from a cross-yoke configuration. FIG. 17a illustrates a straight pole piece; FIG. 17b illustrates an undercut pole piece and FIG. 17c illustrates an angled pole piece. Pole geometries at FIGS. 17b and 17c have a more symmetrical magnetic field compared to the pole geometry at FIG. 17a.

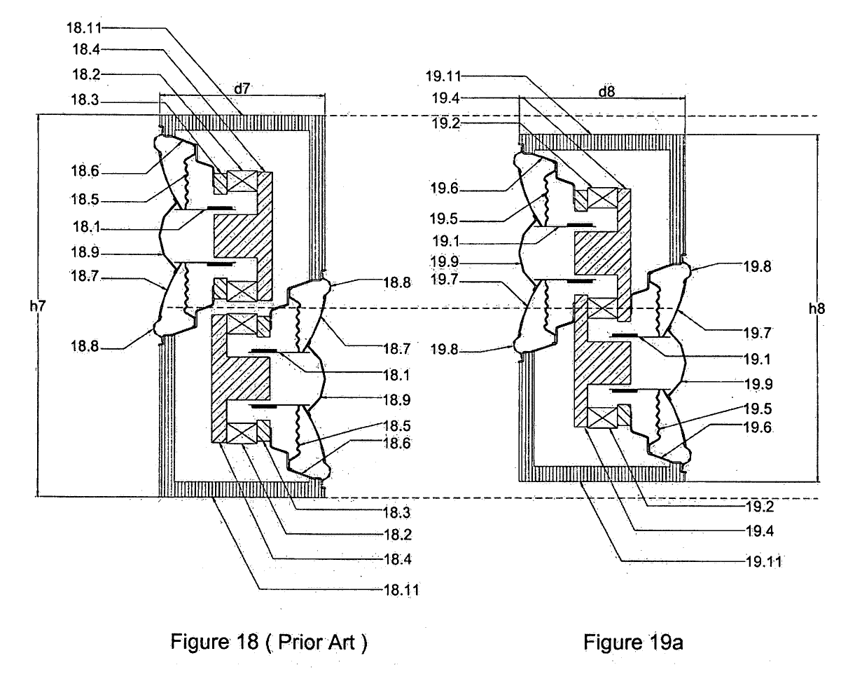

FIG. 18 illustrates a prior art separate bi-polar loudspeaker, using two drivers in side-by-side and back-to-back relation, connected in phase. The system uses a T-yoke configuration. The T-yoke configuration placement in this embodiment is side-by-side and back-to-back. In this configuration, the total thickness of the loudspeaker enclosure is (d7) which less than (d5). The total height of the enclosure (h7) is greater than (h5).

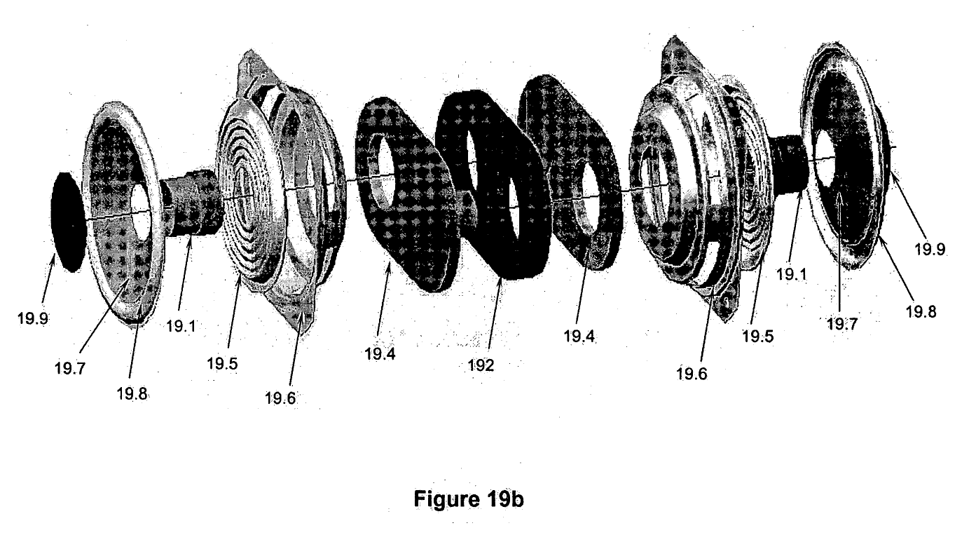

FIGS. 19a and 19b depict the bi-polar loudspeakers of the present invention using an integrated T-yoke and top plate. This is similar to FIG. 16, with the exception that the integrated T-yoke and top plate and the magnet have a unique shape. The magnet [19.3] has an oval shape incorporating two circular holes inside. The integrated T-yoke configuration and plate [19.4] have an oval shaped plate with a circular hole and a circular shaft.

The total thickness of the loudspeaker enclosure [16.11] is (d8). The height of the loudspeaker enclosure is (h8). The prior art arrangement in FIG. 18, although the thickness of loudspeaker enclosure (d8) is the same as (d7), the height of the present loudspeaker enclosure (h8) is less than the height of prior art loudspeaker (h7). As can be seen by comparison to FIG. 18, the present loudspeaker has a smaller loudspeaker enclosure.

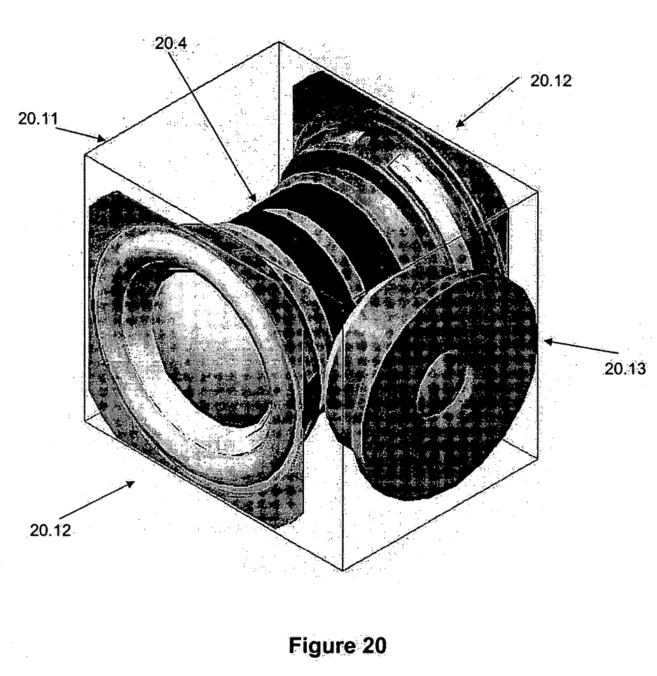

FIG. 20 illustrates an example of a loudspeaker system having an integrated cross-yoke configuration system [20.4], according to the present invention. The arrangement has a separate tweeter driver [20.13] assembled in the same loudspeaker enclosure [20.11] similar to the loudspeaker structure of FIG. 16. The tweeter driver [20.13] placement is in the front side of the loudspeaker enclosure, and the mid-bass driver [20.12] is placed in the left and right sides of the loudspeaker enclosure.

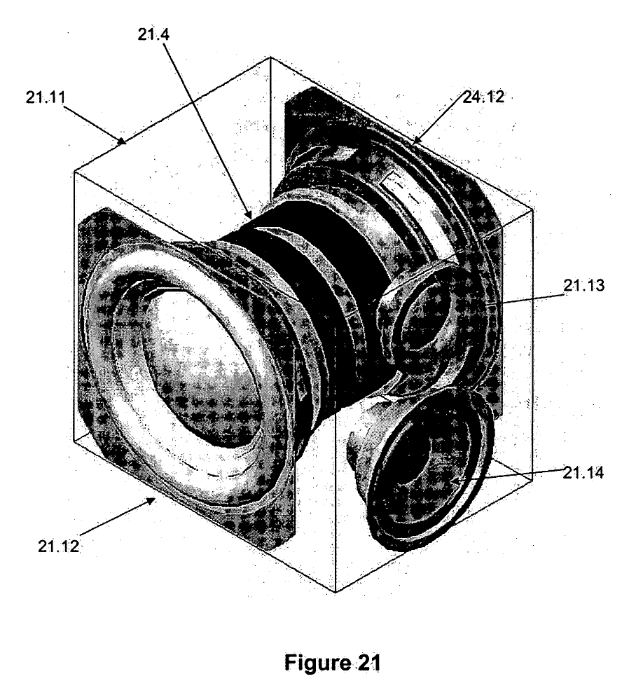

FIG. 21 illustrates a loudspeaker system having an integrated cross-yoke configuration [21.4], with a separate tweeter driver [21.13] and separate midrange driver [21.14] assembled in same loudspeaker enclosure [21.11]. The tweeter [21.13] and midrange [21.14] placement is at the front side of the loudspeaker enclosure; the mid-bass driver [21.12] is positioned in the left and right sides of the loudspeaker enclosure.

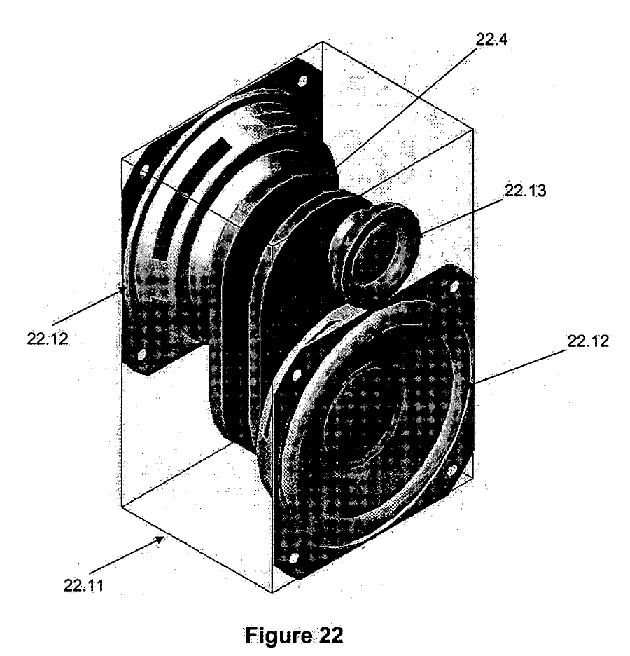

FIG. 22 illustrates a loudspeaker system having an integrated T-yoke configuration and plate configuration [22.4], according to the present invention using a separate tweeter driver [22.13] assembled in the same loudspeaker enclosure [22.11]. The loudspeaker structure is similar to that shown in FIG. 19. The tweeter [22.13] is placed at the upper of one of the mid-bass drivers [22.12] and at the front side of the loudspeaker enclosure. The other mid-bass driver [22.12] put at the back of the loudspeaker enclosure.

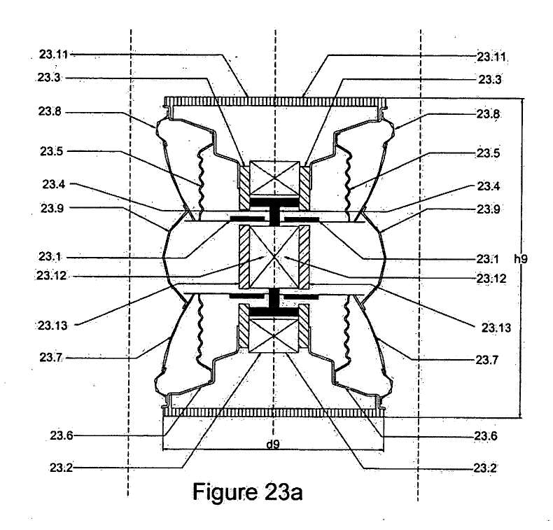

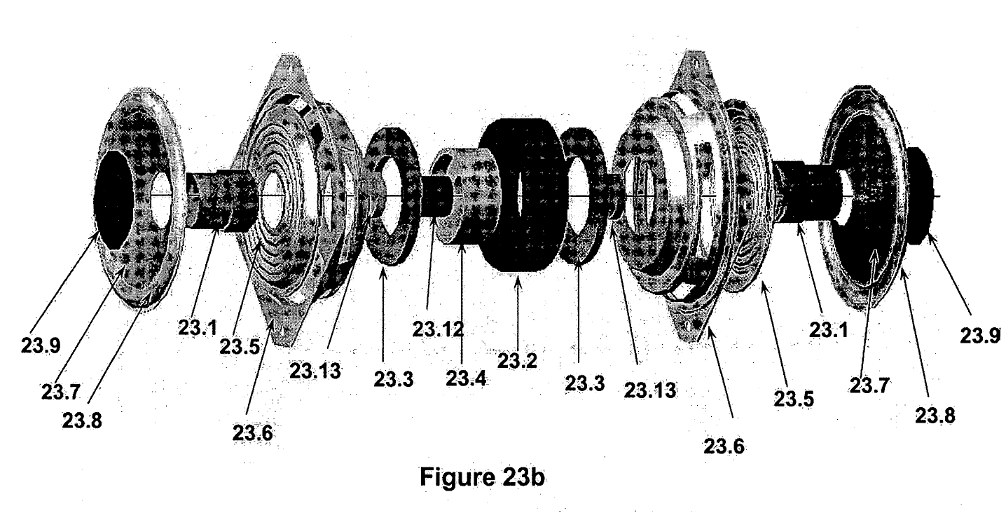

Referring now to FIG. 23a, shown is a cross-sectional view with FIG. 23b illustrating an exploded view of the invented bi-polar loudspeakers having a ring magnet [23.2], a cylindrical magnet [23.12] and a yoke [23.4] commonly connected to each of said individual loudspeaker drivers. Each driver has a voice coil [23.1], a ring top plate [23.3], and a cylindrical top plate [18.13]. A spider [23.5] as the compliance system of the driver, is connected to frame [23.6] and voice coil [23.1]. The diaphragm [23.7] has an edge [23.8] connected to frame [23.6] and voice coil [23.1]. A dust cover [23.9] is provided at the front of the diaphragm [23.7]. Both drivers are within the loudspeaker enclosure [23.11]. The total thickness of the loudspeaker enclosure is (d9), the height of both loudspeakers is (h9), the same dimension as (h5) in FIG. 15. By comparison with the prior art assembly in FIG. 15, the present loudspeaker has the thinnest loudspeaker enclosure. This is due to the fact that the prior art arrangement has two bottom plates and distance between the two loudspeakers; the thickness of invented yoke [23.4] does not influence enclosure thickness. This yoke is made of a non magnetic material.

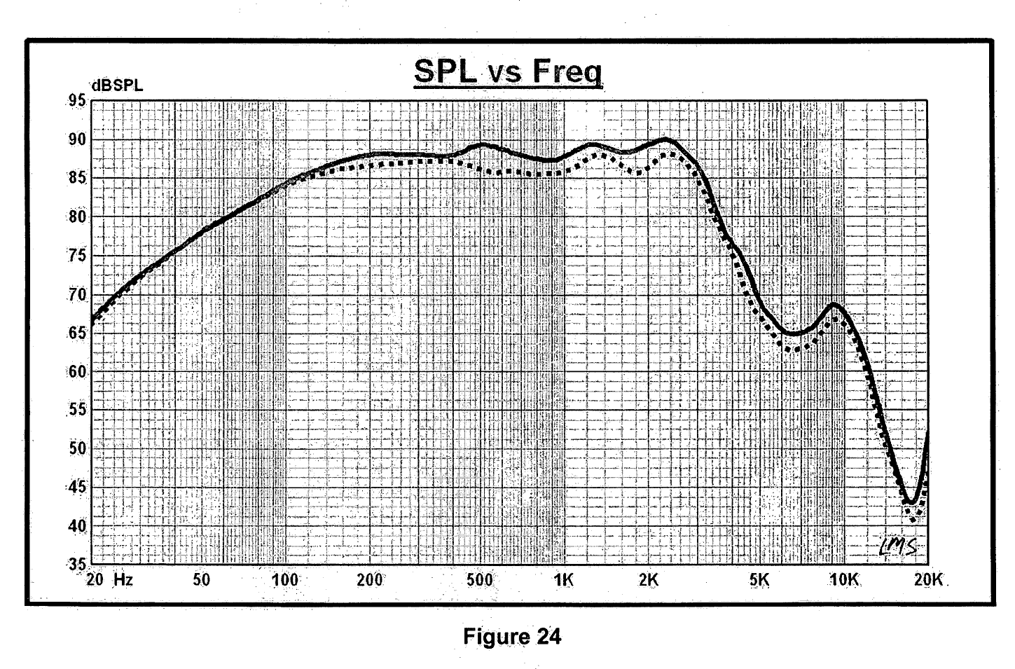

FIG. 24 is an example of frequency response of the prior art of bi-polar loudspeaker using a T-yoke configuration (line curve). The frequency response of the present bi-polar loudspeaker having the same specification as the prior art loudspeaker is illustrated with the doted curve. The same specification means the dimension of the magnet; top plate and pole piece are identical. It is evident from the data that the loudspeaker of the present invention has a higher SPL of 1 to 2 dB, especially at the frequency range between 150 Hz and 10 kHz. The higher SPC is due to greater magnetic field strength (B) relative to the prior art created as a result of the yoke designs discussed herein

Although embodiments of the invention have been described above, it is limited thereto and it will be apparent to those skilled in the art that numerous modifications form part of the present invention insofar as they do not depart from the spirit, nature and scope of the claimed and described invention.

We claim:

1. An integrated multi yoke for use in a loudspeaker having at least two loudspeaker drivers, comprising:
a body having at least two recesses each for receiving a loudspeaker driver; and
a partition common to each recess.

2. The yoke as set forth in claim 1, wherein said body has an I shaped configuration in cross section.

3. The yoke as set forth in claim 1, wherein said body has an S shaped configuration in cross section.

4. The yoke as set forth in claim 1, wherein said body has a cross shaped configuration in cross section.

5. A loudspeaker, comprising:
an enclosure;
a plurality of individual loudspeaker drivers including a diaphragm, spider, frame, top plate and magnet, said individual loudspeaker drivers being mounted adjacent one another within said enclosure; and
an integrated multi yoke commonly connected to each of said individual loudspeaker drivers.

6. The loudspeaker as set forth in claim 5, wherein said yoke has a body, said body having an I shaped configuration.

7. The loudspeaker as set forth in claim 5, wherein said yoke has a body, said body having an S shaped configuration in cross section.

8. The loudspeaker as set forth in claim 5, wherein said yoke has a body, said body having a cross shaped configuration in cross section.

9. The loudspeaker as set forth in claim 5, wherein said individual loudspeaker drivers are connected in phase.

10. The loudspeaker as set forth in claim 5, wherein said loudspeaker is multiple polar.

11. The loudspeaker as set forth in claim 5, wherein said loudspeaker drivers are selected from the group consisting of cone, dome and horn type.

12. A bi-polar loudspeaker, comprising:
an enclosure;
a plurality of individual loudspeaker drivers including a diaphragm, frame and top plate, said individual loudspeaker drivers being mounted adjacent one another within said enclosure; and
a cylindrical magnet, a ring magnet and a yoke commonly connected to each of said individual loudspeaker drivers.
